(19) United States
(12) Patent Application Publication
(10) Pub. No.: US 2021/0166282 A1
(43) Pub. Date: Jun. 3, 2021

(54) Personalized Dynamic Sub-Topic Category Rating from Review Data

(71) Applicant: International Business Machines Corporation, Armonk, NY (US)

(72) Inventors: Scott Nidell, Georgetown, TX (US); Spencer Thomas Reynolds, Austin, TX (US); Wisam Mohammed, San Jose, CA (US); ChunHui Y. Higgins, Raleigh, NC (US)

(73) Assignee: International Business Machines Corporation, Armonk, NY (US)

(21) Appl. No.: 16/700,286

(22) Filed: Dec. 2, 2019

(51) Int. Cl. G06Q 30/02; G06F 40/16; G06N 5/04

(52) U.S. Cl. CPC G06Q 30/0282; G06N 5/04; G06F 40/16

(57) ABSTRACT

Embodiments relate to a computer program product, a computer system and a method using artificial intelligence for dynamically determining sub-category ratings from content commentary of reviews of an online review forum, such as, for example, venue reviews of a crowd-source review forum. In particular embodiments, the computer program product, the computer system, and the method apply the artificial intelligence for dynamically determining sub-category ratings from content commentary of reviews of an online review forum based on personal characteristic data of an entity (e.g., user) profile or entity online history.

### BACKGROUND

The present embodiments relate to a computer program product, a computer system and a method using artificial intelligence for dynamically determining sub-category ratings from content commentary of reviews of an online review forum, such as, for example, venue reviews of a crowd-source review forum. In particular embodiments, the computer program product, the computer system, and the method apply the artificial intelligence for dynamically determining sub-category ratings from content commentary of reviews of an online review forum based on personal characteristic data of an entity (e.g., user) profile or entity online history.

Various online crowd-source review forums such as those provided by social networking websites, travel websites, and booking websites provide capability to search a particular venue of a particular category of venues, such as a particular hotel, restaurant, retail store, theater, or other business or destination. Crowd-source review forums typically provide webpages that allow reviewing entities to submit overall reviews of the goods and services based on individual experiences of the reviewing entities, who are typically the website users. As part of the overall review, the website often asks the reviewing entities to “score” or “grade” the venue by selecting an overall rating based on a website-predetermined rating system. For example, the website may provide a predetermined rating system for the reviewing entities to score the venue with one, two, three, four, or five stars, wherein a one-star rating corresponds to the lowest rating and a five-star rating corresponds to the highest rating. The website often conducts a statistic analysis (e.g., averaging) of the reviewing entity ratings to calculate an overall rating score. Further, for each review by the reviewing entities, the website typically provides the reviewing entities with the option of entering personalized comments (content commentary) reflecting their experiences, anecdotes, and/or opinions of the business or destination.

The websites compile the reviews and provide for reviewing entities (and in open forums for non-reviewing entities who have not submitted a review) to access and search the reviews, including the overall rating score and the content commentary of individual reviews, view a user interface. The websites often also provide the searching entities with a sorting option whereby the searching entities can employ the user interface to sort the reviews from lowest-to-highest (ascending) reviewing-entity scores or highest-to-lowest (descending) reviewing-entity scores. Alternatively or in addition to this sorting option, the websites may provide the searching entity with a refining tool to limit the search results to only a subset of the reviews having a minimum reviewing-entity score, for example, only those reviewing-entity scores that are three stars or higher, four stars or higher, or five stars for a five-star rating system.

A drawback to crowd-source reviews is that reviewing entities have different priorities when it comes to their enjoyment or perception of the reviewed venue, e.g., a business or destination. For example, for the purpose of assessing the overall rating, one reviewing entity may assign highest importance to the sub-topic of affordability, whereas another reviewing entity may assign highest importance to the sub-topic of quality of service or goods, whereas still another reviewing entity may assign highest importance to yet another sub-topic, such as the location, ambience, staff, or other attributes.

The disparities in sub-topic prioritization by reviewing entities is not taken into consideration in computing the overall rating, and more importantly leads to overall ratings that are based on sub-topic prioritizations of reviewing entities that do not align with the priorities of the searching entities accessing the review forum. For example, a searching entity may have a health condition that makes ease of accessibility to a given venue, such as a restaurant, the highest priority for the searching entity. On the other hand, the overall rating may be computed from underlying overall ratings of reviewing entities who place priority on sub-topics other than accessibility (e.g., cleanliness, food quality, etc.). The average overall rating computed from those overall ratings may not reflect the topic priority or priorities of the searching entity. Further, browsing through the tens, hundreds, or even thousands of personalized comments for a specific sub-topic that is of importance to the searching entity, such as accessibility, can be extremely time-consuming and inefficient for the searching entity.

### SUMMARY

The embodiments include a computer program product, a computer system, and a method for using artificial intelligence to dynamically generate a personalized rating for a sub-topic category, and in particular embodiments base the personalized rating for the sub-topic category on personal characteristic data of a searching entity.

An aspect of a first embodiment provides a computer system including a processing unit operatively coupled to memory and an artificial intelligence (AI) platform in communication with the processing unit. The AI platform includes one or more tools to dynamically provide a rating from content commentary of a review of a topic. The A platform includes a natural language (NL) manager, an AI manager, and a director. The NL manager is configured to access the review comprising the content commentary associated with the topic and apply natural language processing (NLP) to the content commentary of the accessed review to generate machine-readable sub-topic data and machine-readable sentiment data corresponding to the sub-topic data, the sub-topic data and the sentiment data being derived by the NLP from the content commentary of the accessed review. The AI manager is configured to apply AI to the sentiment data and the sub-topic data to dynamically identify at least one sub-topic category associated with the sub-topic data, dynamically identify a sentiment associated with the sentiment data, dynamically assess a dynamic value to the dynamically identified sentiment, and dynamically assess a dynamic rating based on the dynamic value. The director is operatively coupled to the AI manage to generate output data, the generated output data being based on the dynamic rating.

An aspect of a second embodiment provides a computer program product to dynamically provide a rating from content commentary of a review associated with a topic. The computer program product includes a computer readable storage medium having program code embodied therewith. The program code is executable by a processor to access the review including the content commentary associated with the topic and apply natural language processing (NLP) to the content commentary of the accessed review to generate machine-readable sub-topic data and machine-readable sentiment data corresponding to the sub-topic data, the sub-topic data and the sentiment data being derived by the NLP from the content commentary of the accessed review. The program code further is executable to apply artificial intelligence (A) to the sub-topic data and the sentiment data to dynamically identify at least one sub-topic category associated with the sub-topic data, dynamically identify a sentiment associated with the sentiment data, dynamically assess a dynamic value to the dynamically identified sentiment, and dynamically assess a dynamic rating based on the dynamic value. The program code also is executable to generate output data, the generated output data being based on the dynamic rating.

An aspect of a third embodiment provides a method including accessing a review including content commentary associated with a topic category and applying natural language processing (NLP) to the content commentary of the accessed review to generate machine-readable sub-topic data and machine-readable sentiment data corresponding to the sub-topic data, the sub-topic data and the sentiment data being derived by the NLP from the content commentary of the accessed review, applying artificial intelligence (AI) to the sub-topic data and the sentiment data, and generating output data. The A dynamically identifies a sub-topic category associated with the sub-topic data, dynamically identifies a sentiment associated with the sentiment data, dynamically assesses a dynamic value to the dynamically identified sentiment, and dynamically assesses a dynamic rating based on the dynamic value. The generated output is based on the dynamic rating.

Other aspects of the invention, including machines, devices, products, code, systems, methods, and processes will become more apparent from the following detailed description of exemplary embodiments, taken in conjunction with the accompanying drawings.

### BRIEF DESCRIPTION OF THE SEVERAL VIEWS OF THE DRAWINGS

The drawings reference herein forms a part of the specification. Features shown in the drawings are meant as illustrative of only some embodiments, and not of all embodiments, unless otherwise explicitly indicated.

FIG. 1 depicts a system diagram illustrating an artificial intelligence platform computing system.

FIG. 2 depicts a block diagram illustrating the artificial intelligence platform tools, as shown and described in FIG. 1, and their associated application program interfaces.

FIGS. 3A and 3B depict a flowchart illustrating a process to establish a data structure containing entries for dynamically identified sub-topic categories and dynamically determined sentiment values.

FIG. 4 depicts a flowchart illustrating a process to establish a data structure containing entries for dynamically identified sub-topic categories, dynamically determined sentiment values, and static sentiment values.

FIGS. 5A and 5B depict a flowchart illustrating a process for outputting an overall rating based on personalized characteristic data and the established data structure of FIGS. 3A and 3B.

FIGS. 6A and 6B depict a flowchart illustrating a process for outputting an overall rating based on personalized characteristic data and the established data structure of FIG. 4.

FIG. 7 depicts a block diagram illustrating an example of a computer system/server of a cloud based support system, to implement the system and processes described above with respect to FIGS. 1-6B.

FIG. 8 depicts a block diagram illustrating a cloud computer environment.

FIG. 9 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

In the field of artificial intelligent computer systems, natural language systems (such as the IBM Watson® artificial intelligent computer system and other natural language question answering systems) process natural language based on knowledge acquired by the system. To process natural language, the system may be trained with data derived from a database or corpus of knowledge.

Machine learning, which is a subset of Artificial Intelligence (AI), utilizes algorithms to learn from data and create foresights based on this data. AI refers to the intelligence when machines, based on information, are able to make decisions, which maximizes the chance of success in a given topic. More specifically, AI is able to learn from a data set to solve problems and provide relevant recommendations. A is a subset of cognitive computing, which refers to systems that learn at scale, reason with purpose, and naturally interact with humans. Cognitive computing is a mixture of computer science and cognitive science. Cognitive computing utilizes self-teaching algorithms that use data minimum, visual recognition, and natural language processing to solve problems and optimize human processes.

Natural Language Processing (NLP) is a field of AI that functions to translate between computer and human languages. More specifically, NLP enables computers to analyze and understand human language. Natural Language Understanding (NLU) is a category of NLP that is directed at parsing and translating input according to natural language principles. As shown and described herein, NLP and NLU are leveraging to evaluate rating data and associated commentary.

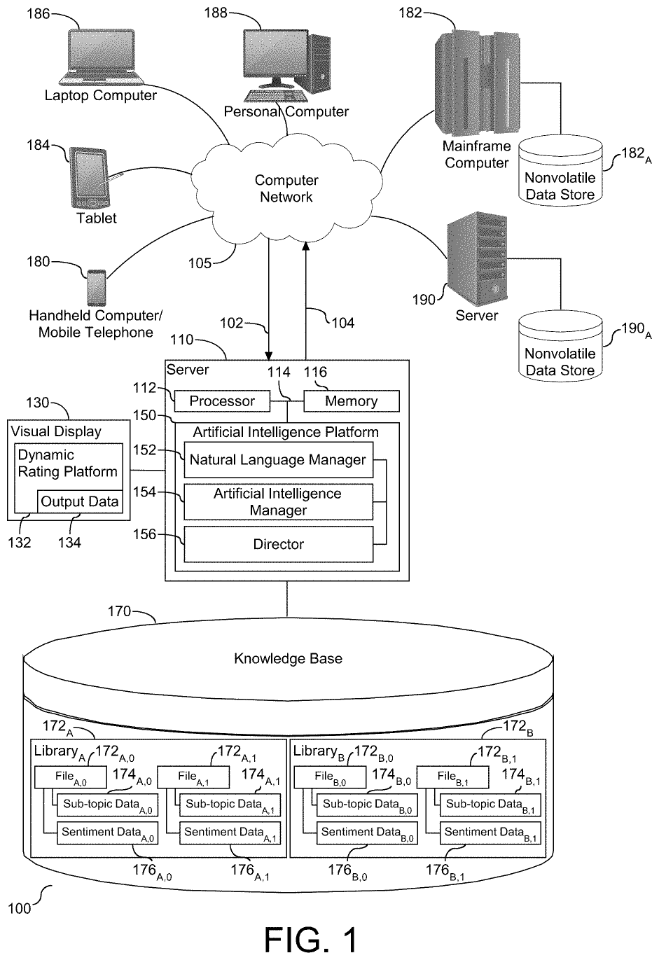

Referring to FIG. 1, a schematic diagram of an artificial intelligence platform computing system (100) is depicted to dynamically determining sub-topic category ratings from content commentary of reviews. As shown, a server (110) is provided in communication with a plurality of computing devices (180), (182), (184), (186), (188), and (190) across a network connection (105). The server (110) is configured with a processing unit (112) in communication with memory (116) across a bus (114). The server (110) is shown with an artificial intelligence (AI) platform (150) for cognitive computing, including natural language processing (NLP) and Natural Language Understanding (NLU), across the network (105) from one or more of the computing devices (180), (182), (184), (186), (188), and (190). More specifically, the computing devices (180), (182), (184), (186), (188), and (190) communicate with each other and with other devices or components via one or more wired and/or wireless data communication links, where each communication link may comprise one or more of wires, routers, switches, transmitters, receivers, or the like. In this networked arrangement, the server (110) and the network connection (105) enable communication detection, recognition, and resolution. Other embodiments of the server (110) may be used with components, systems, sub-systems, and/or devices other than those that are depicted herein.

The artificial intelligence platform (150) is shown in FIG. 1 configured with tools to dynamically assess and assign a rating to content commentary. The tools include, but are not limited to, a natural language (NL) manager (152), an AI manager (154) and a director (156). The AI platform (150) may receive input (102) from the network (105) and leverage a data source (170), also referred to herein as a corpus or knowledge base (170), of electronic documents and files, or other data, content, or other possible sources of input or information to support and enable the dynamic assessment. As shown, the data source (170) is configured with electronic files organized or assigned to one or more libraries. In one embodiment, one or more of the libraries may be distributed across the network (105). Accordingly, the A platform (150) and the corresponding tools (152), (154), and (156) are operatively coupled to the knowledge base (170) and the corresponding one or more libraries.

As shown herein, the knowledge base (170) is configured with libraries populated with files. In the example shown herein, the knowledge base (170) is shown with two libraries, including library_{A} (172_{A}) and library_{B} (172_{B}). Although there are only two libraries shown, this quantity is for illustrative purposes and should not be considered limiting. In one embodiment, each library is populated with one or more files, with the populated file(s) corresponding to categorization of the library. For example, in one embodiment, a library may be a social media site and the files may be sets of commentary to a venue identified or specified by the social media site. As shown in FIG. 1, library_{A} (172_{A}) is shown with two files, shown herein as file_{A,0} (172_{A,0}) and file_{A,1} (172_{A,1}), and library_{B} (172_{B}) is shown with two files, shown herein as file_{B,0} (172_{B,0}) and file_{B,1} (172_{B,1}). Although each library is shown with two files, this quantity is for illustrative purposes and should not be considered limiting. As shown and described herein, the files are subject to processing, including NLP, to assess corresponding content commentary. According to exemplary embodiments, the knowledge base (170) is populated with libraries and files of venue commentary.

The library files are subject to NLP. As shown herein, the NL manager (152) functions to access commentary review of a topic via one or more files in a corresponding library of the knowledge base (170). Each of the files in the libraries includes content commentary. In one embodiment, the individual files are remarks provided by a user of an experience at a venue. The NL manager (152) applies NLP to the content commentary of the accessed file, e.g., a review, and generates machine-readable sub-topic data and machine-readable sentiment data. As shown herein by way of example, file_{A,0} (172_{A,0}) is shown with machine-readable sub-topic data_{A,0} (174_{A,0}) and machine-readable sentiment data_{A,0} (176_{A,0}), file_{A,1} (172_{A,1}) is shown with machine-readable sub-topic data_{A}, (174_{A,1}) and machine-readable sentiment data_{A}, (176_{A,1}), file_{B,0} (172_{B,0}) is shown with machine-readable sub-topic data_{B,0} (174_{B,0}) and machine-readable sentiment data_{B,0} (176_{B,0}), and file_{B,1} (172_{B,1}) is shown with machine-readable sub-topic data_{B,1} (174_{B,1}) and machine-readable sentiment data_{B,1} (176_{B,1}). The sub-topic data and the sentiment data is derived by the NL manager (152) and the corresponding NLP from the content commentary of the accessed review in the respective file.

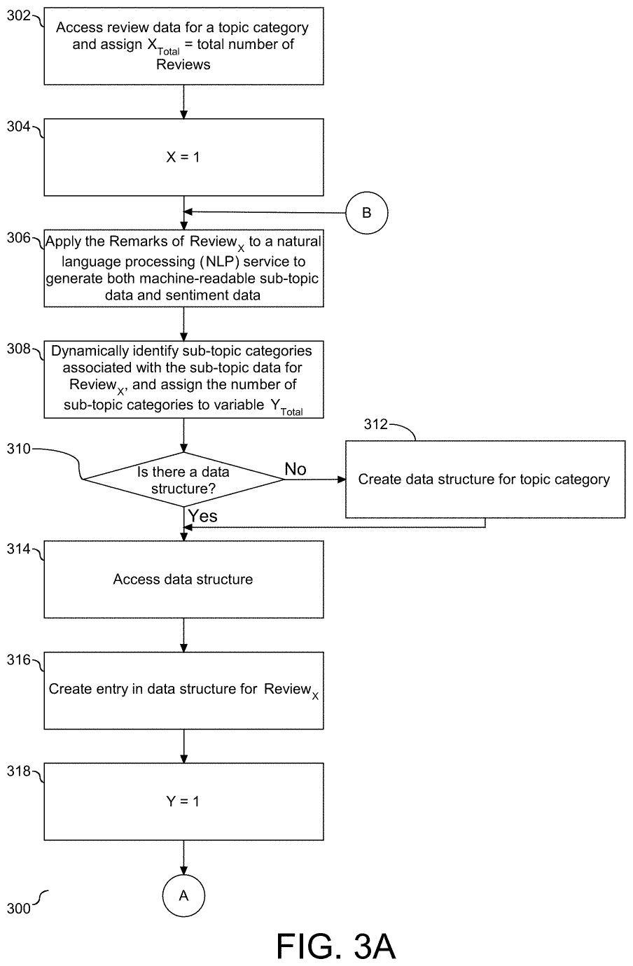

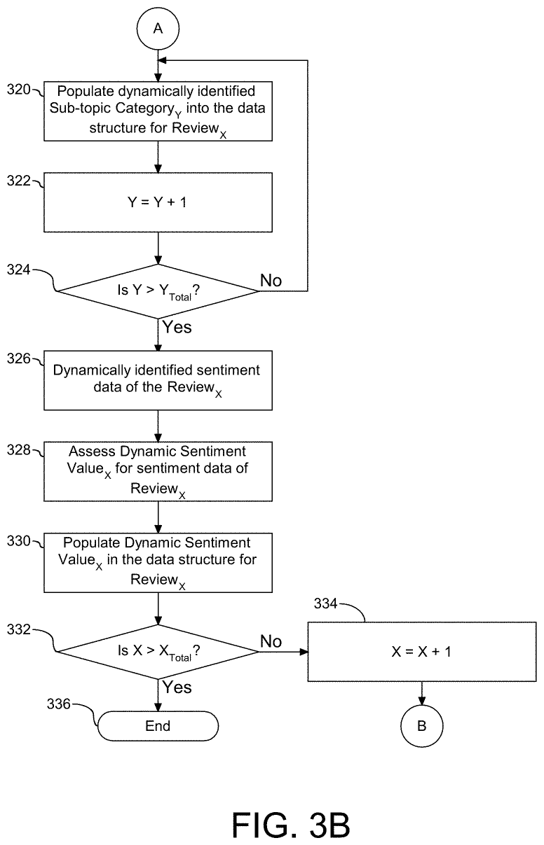

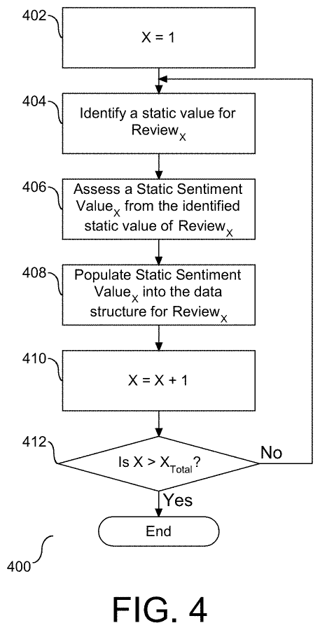

The AI manager (154), which is shown herein operatively coupled to the NL manager (152), is configured to apply AI to the sentiment data and the sub-topic data. More specifically, the AI manager (154) is configured to dynamically identify at least one sub-topic category associated with the sub-topic data, dynamically identify a sentiment associated with the sentiment data, dynamically assess a dynamic value to the dynamically identified sentiment, and dynamically assess a dynamic rating for the access review data based on the dynamic value. Details of the dynamic identification and dynamic assessment are shown and described in FIGS. 3 and 4. As shown herein, a visual display (130) is operatively coupled to the server (110) with a supporting dynamic rating platform (132). In one embodiment, the visual display (130) and the platform (132) may be local to one or more of the computing devices operatively coupled to the server (110) across the network (105). The director (156), which is operatively coupled to the AI manager (154), generates output data (134) based on the dynamic rating, and conveys the output data (134) on the associated platform (132). Accordingly, the AI platform (150) interfaces with the knowledge base (170) and the dynamic rating platform (132) to dynamically rate and convey content commentary of a review of a topic.

The AI platform (150) is configured to access multiple reviews, with each review including content commentary associated with a topic category. It is understood in the art that there are two primary aspects of content commentary review data, including quality and quantity. A larger quantity of reviews received for a topic category strengthens the value of the reviews, and in one embodiment may discount one or more review outliers. The NL manager (152) subjects the reviews to NLP to generate the machine readable sub-topic and sentiment data, and the AI manager (154) functions to dynamically assess and identify one or more sub-topic categories associated with the sub-topic data. The AI manager (154) functions to dynamically identify sentiment associated with the generated sentiment data, and dynamically assess a value to the sentiment data and a rating based on the value, which is conveyed to the platform (132) as output data (134).

As briefly described above, the AI manager (154) supports and enables dynamic processing directed at the sentiment data and the sub-topic data. In addition, the AI manager (154) also applies AI to identify a static value for the accessed review and to assess a static rating based on the static value. Static values are scores, grades, ratings, or other valuating indicia entered by the reviewing entity and typically pre-existing in the review database when the review database is accessed by the reviewing entity. Details of assessment of the static rating based on the static value are shown and described in FIG. 4. Application of AI to the static values may factor into the generated output data (134).

Personal characteristic data of an entity, such as the searching entity, may play a role in the review content rating. In an embodiment, the personal characteristic data comprise, for example, demographic characteristic data such as physical impairment, age, religious affiliation, ethnicity, geographical location, a combination thereof, or others. In an embodiment, the AI manager (154) derives or accesses personal characteristic data from, for example, a hypertext transfer protocol (HTTP) cookie or cookies of the computer device, a social media profile, a social media site, or a combination thereof, or others. From the personal characteristic data, the AI manager (154) identifies at least one area of interest. The area(s) of interest may be, e.g. accessibility, diversity, snorkeling, skiing, sun-bathing, etc. The AI manager (154) leverages the identified area(s) of interest and applies it to the access reviews, and more specifically dynamically determines if there is a commonality shared between a sub-topic category and the identified area of interest, dynamically determines a dynamic value for the accessed review, identifies a respective static value for the access review, assesses a respective dynamic rating based on the respective dynamic value, and assesses a respective static rating based on the respective static value. The generated output (134) is selectively adjusted by the director (156) responsive to the commonality assessments. More specifically, the generated output data (134) is based on the respective dynamic ratings and the respective static ratings of the accessed reviews for which the respective at least one sub-topic category (also referred to herein as a “sub-category”) shares commonality with the identified at least one area of interest, and the generated output data (134) is not based on the respective dynamic rating and the respective static ratings of the accessed reviews for which the respective at least one sub-topic category does not share commonality with the identified at least one area of interest.

In exemplary embodiments, the knowledge base (170) is configured with a library of review data, the review data, represented herein as files, including content commentary. In an embodiment, one or more of the libraries (172_{A}) and (172_{B}) may be distributed across the computer network (105). Accordingly, the AI platform (150) and the corresponding tools (152), (154), and (156) are operatively coupled to the knowledge base (170) and the corresponding review data with content commentary. In an embodiment, the knowledge base (170) may be configured with other or additional sources of input, and as such, the sources of input shown and described herein should not be considered limiting. Similarly, in an embodiment, the knowledge base (170) includes structured, semi-structured, and/or unstructured content in a plurality of documents that are contained in one or more databases or corpus. The various computing devices (180), (182), (184), (186), and (188) in communication with the network (105) may include access points for content creators and content users. Some of the computing devices (180), (182), (184), (186), and (188) may include devices for a database storing the corpus of data as the body of information used by the AI platform (150) to generate response output (134), and to communicate the response output to the dynamic platform (132) operatively coupled to the server (110) or one or more of the computing devices (180), (182), (184), (186), and (188) across network connection (104).

The network (105) may include local network connections and remote connections in various embodiments, such that the artificial intelligence platform (150) may operate in environments of any size, including local and global, e.g., the Internet. Additionally, the AI platform (150) serves as a front-end system that can make available a variety of knowledge extracted from or represented in documents, network accessible sources and/or structured data sources. In this manner, some processes populate the AI platform (150), with the A platform (150) also including input interfaces to receive requests and respond accordingly.

As shown, content may be in the form of one or more electronic documents, shown herein as files (172_{A,0}), (172_{A,1}), (172_{B,0}), and (172_{B,1}), which may be, for example, data source entries, for use as part of the corpus (170) of data with the A platform (150). The corpus (170) may include any structured and/or unstructured documents, including but not limited to any file, text, article, or source of data for use by the artificial intelligence platform (150). Content users may access the AI platform (150) via a network connection or an Internet connection to the network (105), and may submit natural language input to the AI platform (150) that may effectively be processed into context-based word(s), phrase(s), sentence(s), document(s), or vector representation. As further described below, the NLP functions to process NL and generate machine-readable data.

Context in the form of sub-topic data and sentiment data is communicated to the AI platform (150), so that the context may be interpreted and utilized by the AI platform (150). As shown, the AI platform (150) is local to the server (110). In illustrative embodiments, the server (110) may be the IBM Watson system available from International Business Machines Corporation of Armonk, N.Y., which is augmented with the mechanisms of the illustrative embodiments described hereafter. The AI platform (150) is shown in FIG. 1 configured to receive input across the computer network (105) and leverage the data source or knowledge base (170) to support content detection and processing. As shown, the AI platform (150) utilizes tools, including the NL manager (152), the AI manager (154), and the director (156). Though shown as being embodied in or integrated with the server (110), the AI platform (150) and the associated managers (152) and (154), and the director (156) may be implemented in a separate computing system (e.g., the server 190) or systems that is/are connected across the network (105) to the server (110). Wherever embodied, the managers (152) and (154) and the director (156) function to provide and assess contextual analysis of content commentary with respect to the associated context.

It is understood that the AI platform (150) leverages data from the knowledge base (170). In an embodiment, the content commentary is in the form of a file (172_{A,0}) and includes review data with content commentary. The review data may relate to a particular topic, especially a particular venue, such as a hotel, restaurant, vacation destination, movie theater, hospital, etc. The review data provides the sentiments of a reviewing entity concerning different aspects of the venue. In some instances, the review data may include an overall rating assigned by the reviewing entity. For example, the reviewing entity may provide an overall rating for the venue on a scale, such as five-star scale in which a one-star score represents the lowest approval rating and a five-star score represents the highest approval rating. The knowledge base (170) may be configured with domains and logically grouped activity data in the form of model(s), structure(s), and/or module(s).

The NL manager (152) may receive content commentary, e.g., a file, from sources other than the knowledge base (170), including the various computing devices (180), (182), (184), (186), (188), and (190) in communication with the computer network (105). Once the commentary content is received, the NL manager (152) functions to subject the received file, e.g., file (172_{A,0}) from the knowledge base (170), to NLP to convert the review data into machine-readable data. In one embodiment, the NLP converts the review data, including the content commentary, to one or more vectors, with the one or more vectors representing a numerical profile of two or more document characteristics.

The NL manager (152) further assesses the document characteristics to produce a characteristic score for each document characteristic. In an embodiment, the NL manager assesses the vector to identify the component values that comprise the vector. Accordingly, the NL manager (152) subjects a document to NLP and identifies vector scores, document characteristics, and characteristic scores in the document.

Types of information handling systems that can utilize the server (110) range from small handheld devices, such as the handheld computer/mobile telephone (180) to large mainframe systems, such as the mainframe computer (182). Examples of the handheld computer (180) include personal digital assistants (PDAs), personal entertainment devices, such as MP4 players, portable televisions, and compact disc players. Other examples of information handling systems include the tablet (with or without a pen) computer (184), the laptop or notebook computer (186), the personal computer (188), and the server (190). As shown, the various information handling systems can be networked together using the computer network (105). Types of computer networks (105) that can be used to interconnect the various information handling systems include Local Area Networks (LANs), Wireless Local Area Networks (WLANs), the Internet, the Public Switched Telephone Network (PSTN), other wire and wireless networks, and any other network topology that can be used to interconnect the information handling systems. Many of the information handling systems include nonvolatile data stores, such as hard drives and/or nonvolatile memory. Some of the information handling systems may use separate nonvolatile data stores (e.g., the server (190) utilizes the nonvolatile data store (190_{A}), and the mainframe computer (182) utilizes the nonvolatile data store (182_{A})). The nonvolatile data stores (182_{A}) and/or (190_{A}) can be a component that is external to the various information handling systems or can be internal to one of the information handling systems.

The system and tools shown in and described in connection with FIG. 1 are designed to be applied into a real-world application. In an embodiment, the application may be directed to a natural language processing (NLP) environment. For example, an online crowd-sourcing website may provide searching capabilities to find a venue or destination, such as a vacation resort in a certain country or a restaurant in a certain city. In the case of the restaurant example, the website may identify multiple restaurants in a certain city, such as Abel's, Bob's, and Charlie's. A reviewing entity, typically a patron, of Charlie's may leave a review with an overall score, such as one to five stars one a five-star rating system. The reviewing entity may also include written remarks or “content commentary” in sentence, paragraph, bullet point, or other format describing their sentiments. For example, the patron might describe several sub-topics associated with Charlie's restaurant, such as the quality of the food, affordability, and the attentiveness of the servers, e.g., waiters and waitresses. The sentiments may include descriptive words such as “tasty,” “overcooked,” or “average” with respect to the food quality, “expensive,” “cheap,” or “reasonable” with regard to prices, and “attentive” or “poor” with regard to service. The patron may give Charlie's restaurant a static value such as a three-star rating. For a successful crowd-sourcing website, website user traffic might leave reviews for each venue totaling in the tens, hundreds, or even thousands for restaurants like Abel's Bob's, and Charlie's. Searching all of the review data for a particular sub-topic, such as accessibility, can be a time-consuming and onerous task.

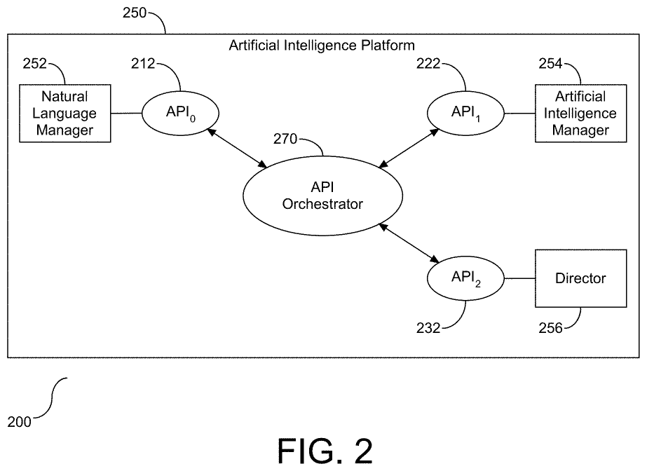

An Application Program Interface (API) is understood in the art as a software intermediary between two or more applications. With respect to the AI platform (150) shown and described in FIG. 1, one or more APIs may be utilized to support one or more of the tools (152), (154), and (156), shown herein as tools (252), (254), and (256), and their associated functionality. Referring to FIG. 2, a block diagram (200) is provided illustrating the tools (252), (254), and (256) and their associated APIs. As shown, a plurality of tools is embedded within the AI platform (205), with the tools including the natural language manager (152) shown in FIG. 2 as (252) associated with API₀ (212), the artificial intelligence manager (154) shown in FIG. 2 as (254) associated with API₁ (222), and the director (156) shown in FIG. 2 as (256) associated with API₂ (232).

Each of the APIs may be implemented in one or more languages and interface specifications. API₀ (212) provides functional support to receive and process natural language, such as, but not limited to, review data and associated commentary, and generates sentiment data and sub-topic data; API₁ (222) provides functional support to apply Artificial Intelligence to the generated sentiment data and sub-topic data, including dynamic identification and assessment thereof; API₂ (232) provides functional support to generate output data based on the dynamic rating generated by API₁ (222) (and in some embodiments the output data is also based on a static rating, discussed below). As shown, each of the APIs (212), (222), and (232) are operatively coupled to an API orchestrator (270), otherwise known as an orchestration layer, which is understood in the art to function as an abstraction layer to transparently thread together the separate APIs. In one embodiment, the functionality of the separate APIs may be joined or combined. As such, the configuration of the APIs shown herein should not be considered limiting. Accordingly, as shown herein, the functionality of the tools may be embodied or supported by their respective APIs.

Referring to FIGS. 3A and 3B, a flowchart illustrates a process (300) to establish a data structure containing entries for sub-topic categories and dynamically assessed sentiment values of corresponding commentary of one or more reviews.

Referring to FIGS. 3A and 3B, at step (302) a searching entity, such as a consumer searching the website for a complementary venue, accesses the review data for a topic category, which in one embodiment may be a commercial venue such as a restaurant like Charlie's. The review data includes at least one review having content commentary. As mentioned above, depending upon the popularity and traffic of the website, the review data might include tens, hundreds, or thousands of reviews by distinct reviewing entities. The value X_{Total} is assigned to the total number of reviews, e.g., if there are 500 reviews, X_{Total} will equal 500.

At step (304), the review counting variable X is initialized, which corresponds to the first review or “Review 1.” At step (306), natural language processing (NLP) is applied to the content commentary of the accessed review, e.g., Review_{X}, to generate machine-readable sub-topic data and machine-readable sentiment data. In some embodiments, the machine-readable data comprises vectors, e.g., word, phrase, sentence, document, other vector representations, or combinations thereof. At step (308), artificial intelligence (AI) is applied to the sub-topic data and the sentiment data to dynamically identify a sub-topic category or a plurality of sub-topic categories (e.g., food quality, affordability, service, etc.) from the sub-topic data, and the quantity of sub-topic categories is assigned to the value Y_{Total}. For example, if Review_{X} discusses food quality and service only, then the A will dynamically identify two sub-topic categories, so that Y_{Total} will equal 2.

At step (310), a determination is made whether a data structure exists. The data structure may be embodied as a table, spreadsheet, database, library or other structure or manner of organizing data. If the data structure already exists, then it is accessed at step (314). On the other hand, if the data structure does not exist, it is created at step (312) and accessed in step (314). An entry is made in the data structure for Review_{X} at step (316).

A sub-topic category counting variable, Y, for Review_{X} (e.g., Review 1) is initialized at step (318). The dynamically identified sub-topic category_{Y} is populated into the data structure for Review_{X} at step (320). Next, at step (322) the sub-topic category counting variable Y is incremented. At step (324), a determination is made whether each of the identified sub-topic categories have been populated into the data structure. If the response to the determination is negative, then the process returns to step (320) and the next dynamically identified Sub-topic Category_{Y} for Review_{X} is populated into the data structure. This process is repeated until all dynamically identified sub-topic categories for Review_{X} are populated into the data structure. When step (322) increases Y to a value greater than Y_{Total} as determined at step (324), the dynamically identified sentiment data of the Review_{X} is identified at step (326), and a Dynamic Sentiment Value_{X} for the dynamically identified sentiment data for Review_{X} is assessed at step (328). Thereafter, the Dynamic Sentiment Value_{X} is populated into the data structure for Review_{X} at step (330).

At step (332), a determination is made whether X is greater than X_{Total}, that is, whether all of the reviews have been processed. If the response to the determination is negative, there are additional reviews to process, and the review counting variable is incremented at step (334) before returning to step (306) for submitting the Remarks of Review_{X} to the NLP service. On the other hand, once all of the reviews have been processed, e.g., such that X is greater than X_{Total}, the population of the data structure is concluded (336).

FIG. 4 depicts a flowchart illustrating a process (400) to establish a data structure containing entries for sub-topic categories, dynamically assessed sentimental values or ratings, and static values or ratings for reviews. Static values are scores, grades, ratings, or other valuating indicia entered by the reviewing entity and typically pre-existing in the review database when the review database is accessed by the reviewing entity. The description above with respect to those steps of FIGS. 3A and 3B is incorporated herein by reference to the description of FIG. 4.

The review counting variable, X, is initialized (402) and a static value of Review_{X} is identified (404). In step (406), a Static Sentiment Value_{X} is assessed from the identified static value of the Review_{X} using the same rating scale as the Dynamically Determined Sentiment Value_{X}, as shown and described in FIGS. 3A and 3B. In an embodiment, assessing the Static Sentiment Value_{X} at step (406) involves conversion of the static value of the Review_{X} using a conversion factor or formula. In an embodiment, the static value for Review_{X} may use the same rating scale of the Dynamically Determined Sentiment Value_{X}, such that the assessing step (406) does not require a conversion, i.e., the static value of the Review_{X} equals the Static Sentiment Value_{X}.

In step (408), the Static Value_{X} is populated into the data structure for Review_{X}. In an embodiment, the Dynamic Sentiment Value_{X} and the Static Sentiment Value_{X} are populated into the same data structure, which may be embodied as a table, spreadsheet, database, library, or other structure or manner of organizing data. In another embodiment, the Dynamic Sentiment Value_{X} and the Static Sentiment Value_{X} are populated in different data structures, e.g., Database₁ and Database₂ (or Dynamic Database and Static Database), respectively. Following step (408), the review counting variable, X, is incremented (410), followed by assessing if each of the reviews have been assessed (412), where the reviews being assessed is defined in FIG. 3A, e.g. step (302). A negative response to the determination at step (412) is followed by a return to step (404), and a positive response concludes the dynamic assessment process.

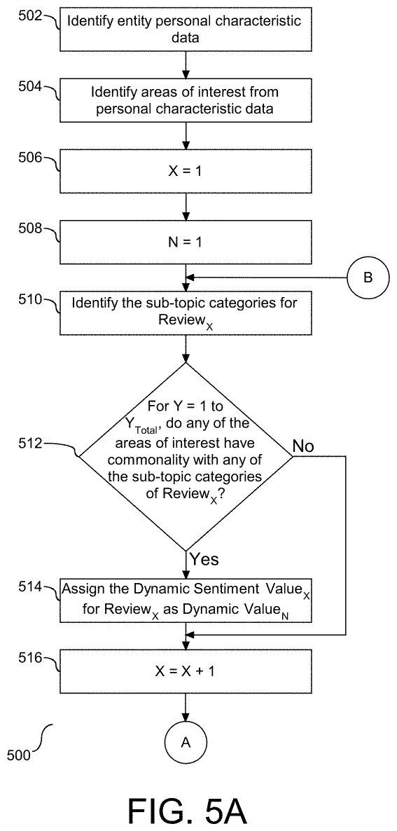

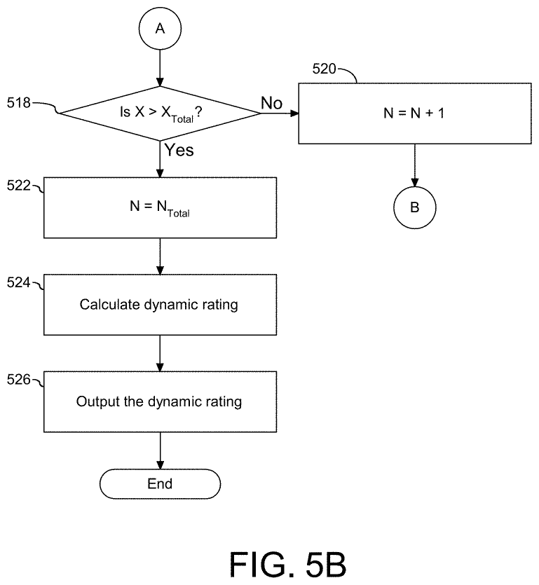

FIGS. 5A and 5B depicts a flowchart illustrating a process (500) for outputting an overall dynamic rating based on personalized characteristic data and the data structure established by the flow diagram of FIGS. 3A and 3B.

At step (502), personal characteristic data of an entity, such as the searching entity, are identified. In an embodiment, the personal characteristic data comprise, for example, demographic characteristic data such as physical impairment, age, religious affiliation, ethnicity, geographical location, a combination thereof, or others. In an embodiment, the personal characteristic data can be derived from, for example, a hypertext transfer protocol (HTTP) cookie or cookies of the computer device, a social media profile, a social media site, or a combination thereof, or others. From the personal characteristic data, at least one area of interest is identified at step (504). The area(s) of interest may be, e.g., accessibility, diversity, snorkeling, skiing, sun-bathing, etc.

Following the identification at step (504), the review counting variable X is initialized (506), and a commonality counting variable N is initialized (508). Each of the sub-topic category or categories, e.g., Y_{Total}, for Review_{X} is identified from the data structure in step (510).

In step (512), a determination is made whether any of the areas of interest from step (504) have commonality with any of the sub-topic categories Y_{Total} for Review_{X}. The sub-topic review categories are defined in FIGS. 3A and 3B. In one embodiment, Natural Language Understanding (NLU), which is a subtopic of Natural Language Processing (NLP), is employed to assess the commonality at step (512) and identify an intersection of one or more areas of interest with any of the sub-topic categories. A positive response to the determination at step (512) is an indication that commonality is determined, and the Dynamic Sentiment Value_{X} for Review_{X} is assigned as Dynamic Value_{N} at step (514).

A negative response to the determination at step (512) is an indication that Review_{X} is not considered further for the purpose of accessing an overall dynamic rating. Following the commonality identified at step (514) or the negative response to the determination at step (512), the review counting variable X is incremented (516). Thereafter, it is determined whether all of the Reviews, X_{Total}, have been processed (518), where the reviews being assessed is defined in FIG. 3A, e.g. step (302). A negative response at step (518) is followed by an increment of the commonality counting variable, N, (520), followed by a return to step (510) to process the next review. If the determination at step (520) finds that all of the reviews, X_{Total}, have been processed, then the commonality counting variable is assigned to the value N_{Total} (522), where N_{Total} represents the total number of Reviews that share commonality with any of the areas of interest.

At step (524), a Dynamic Rating is calculated as follows:

Dynamic Rating=Σ₁^{NTotal}(DynamicValue_{N})/N_{Total}

In other embodiments, the Dynamic Rating may be based on other computations applied to the set of Dynamic Values. For example, different weighting may be given to the set of Dynamic Values based on, for example, the number of areas of interest having commonality with the sub-topic categories of the Review associated with each of the Dynamic Values (see step (512)). The Dynamic Rating from step (524) is then output at step (526), and the process concludes.

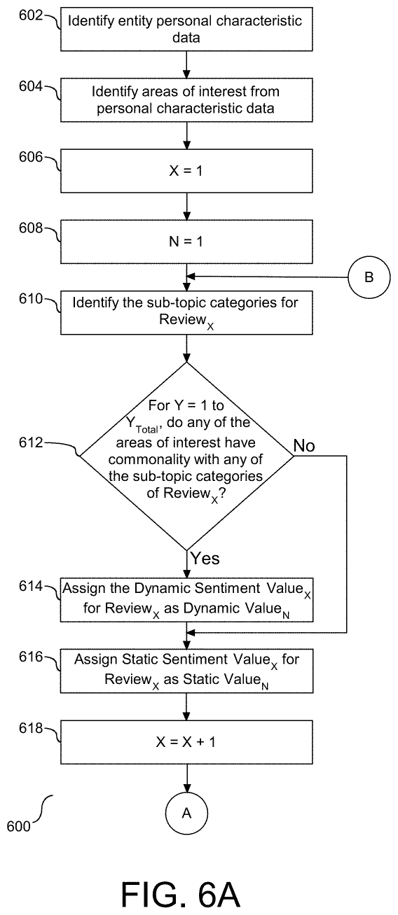

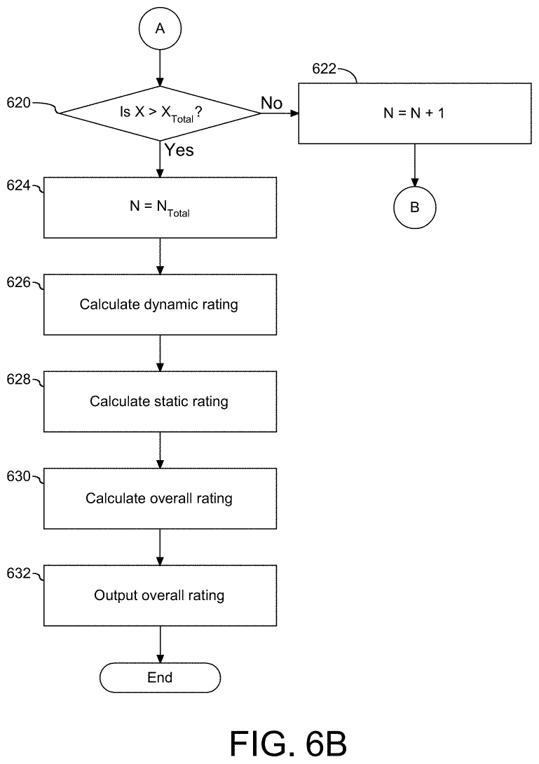

Referring to FIGS. 6A and 6B, a flowchart (600) is provided to illustrate a process for outputting an overall rating based on personalized characteristic data and the data structure established by the flow diagram of FIG. 4.

At step (602), personal characteristic data of an entity, such as the searching entity, are identified, in a manner similar to step (502) described above. From the personal characteristic data, at least one area of interest is identified at step (604). The review counting variable X is initialized (606), and a commonality counting variable N is initialized (608). Each of the sub-topic category or categories, e.g., Y_{Total}, for Review_{X} is identified from the data structure in step (610).

In step (612), a determination is made whether any of the areas of interest from step (604) have commonality with any of the sub-topic categories Y_{Total} for Review_{X}. In one embodiment, Natural Language Understanding (NLU), which is a subtopic of Natural Language Processing (NLP), is employed to assess the commonality at step (612) and identify an intersection of one or more areas of interest with any of the sub-topic categories. A positive response to the determination at step (612) is an indication that commonality is determined, and the Dynamic Sentiment Value_{X} for Review_{X} is assigned as Dynamic Value_{N} at step (614) and the Static Sentiment Value_{X} for Review_{X} is assigned as Static Value_{N} at step (616).

A negative response to the determination at step (612) is an indication that Review_{X} is not considered further for the purpose of accessing an overall dynamic rating. Following the commonalities identified at steps (614) and (616) or the negative response to the determination at step (612), the review counting variable X is incremented (618). Thereafter, it is determined whether all of the Reviews, X_{Total}, have been processed (620). A negative response at step (620) is followed by an increment of the commonality counting variable, N, (622), followed by a return to step (610) to process the next review. If the determination at step (622) finds that all of the reviews, X_{Total}, have been processed, then the commonality counting variable is assigned to the value N_{Total} (624), where N_{Total} represents the total number of Reviews that share commonality with any of the areas of interest.

At step (626), a Dynamic Rating is calculated as follows:

$$Dynamic Rating = {\sum }_{1}^{NTotal} ( {DynamicValue}_{N} ) / {N}_{Total}$$

At step (628) a Static Rating is calculated as the average of the Static Value N₁ to Static Value N_{Total}, that is,

Static Rating=Σ₁^{NTotal}(StaticValue_{N})/N_{Total}

In other embodiments, the Dynamic Rating and/or Static Rating may be based on other computations applied to the set of Dynamic Values and/or Static Values. For example, different weighting may be given to the set of Dynamic Values and/or the Static Values based on, for example, the number of areas of interest having commonality with the sub-topic categories of the Reviews_{X} associated with each of the Dynamic Values and/or the Static Values (see step (612)).

At step (630), an Overall Rating is calculated as the average of the Dynamic Rating of step (626) and the Static Rating of step (628). In other embodiments, the Overall Rating may be based on other computations applied to the Dynamic Rating and the Static Rating may be calculated differently. For example, different weighting may be given to the Dynamic Rating and the Static Rating. The Overall Rating is then output at step (632), and the process (600) terminates.

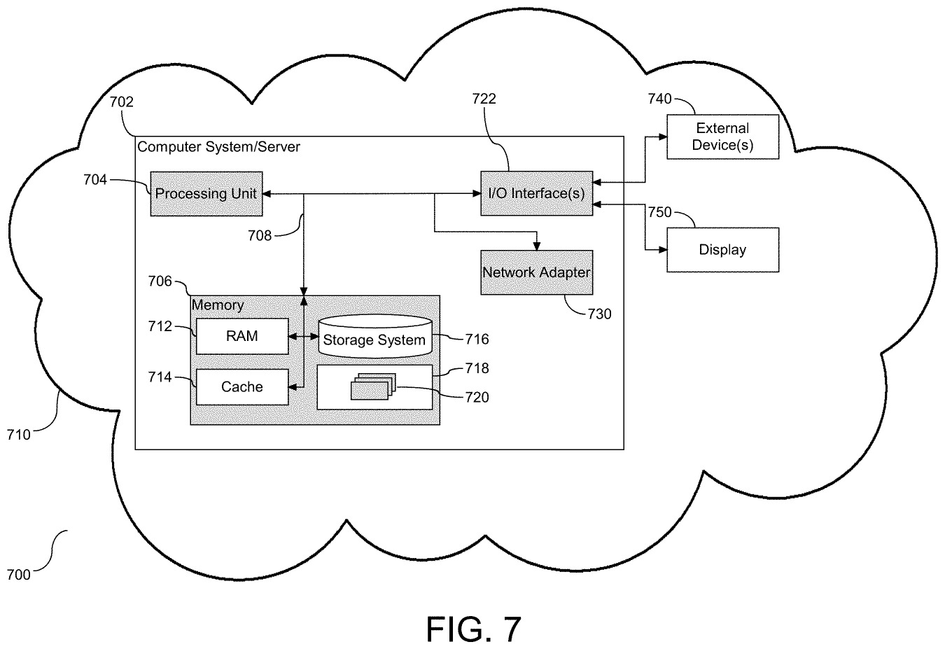

Embodiments shown and described herein may be in the form of a computer system for use with an intelligent computer platform for identifying sub-category and sentiment information in reviews, such as found on a crowd-source website, and providing a personalized rating based on the personal characteristics or traits of an entity, such as the user or searching entity. The embodiments and their associated functionality may be embodied in a computer system/server in a single location, or in one embodiment, may be configured in a cloud based system sharing computing resources. With reference to FIG. 7, a block diagram (700) is provided illustrating an example of a computer system/server (702), hereinafter referred to as a host (702) in a cloud computing environment (710), to implement the system, tools, and processes described above with respect to FIGS. 1-6B. Host (702) is operational with numerous other general purpose or special purpose computing system environments or configurations. Examples of well-known computing systems, environments, and/or configurations that may be suitable for use with host (702) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

The host (702) may be described in the general context of computer system-executable instructions, such as program modules, being executed by a computer system. Generally, program modules may include routines, programs, objects, components, logic, data structures, and so on that perform particular tasks or implement particular abstract data types. The host (702) may be practiced in distributed cloud computing environments where tasks are performed by remote processing devices that are linked through a communications network. In a distributed cloud computing environment, program modules may be located in both local and remote computer system storage media including memory storage devices.

The host (702) is shown in the form of a general-purpose computing device. The components of the host (702) may include, but are not limited to, one or more processors or processing units (704), e.g., hardware processors, a system memory (706), and a bus (708) that couples various system components including the system memory (706) to the processing unit(s) (704). The bus (708) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. The host (702) typically includes a variety of computer system readable media. Such media may be any available media that is accessible by the host (702) and it includes both volatile and non-volatile media, removable and non-removable media.

The system memory (706) can include computer system readable media in the form of volatile memory, such as random access memory (RAM) (730) and/or cache memory (732). By way of example only, storage system (734) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus (708) by one or more data media interfaces.

Program/utility (740), having a set (at least one) of program modules (742), may be stored in memory (706) by way of example, and not limitation, as well as an operating system, one or more application programs, other program modules, and program data. Each of the operating systems, one or more application programs, other program modules, and program data or some combination thereof, may include an implementation of a networking environment. Program modules (742) generally carry out the functions and/or methodologies of embodiments to detect the accuracy of annotation patterns and dynamically apply a weight score to construct ground truth data. For example, the set of program modules (742) may include the tools (152)-(158) as described in FIG. 1.

Host (702) may also communicate with one or more external devices (714), such as a keyboard, a pointing device, etc.; a display (724); one or more devices that enable a user to interact with host (702); and/or any devices (e.g., network card, modem, etc.) that enable host (702) to communicate with one or more other computing devices. Such communication can occur via Input/Output (I/O) interface(s) (722). Still yet, host (702) can communicate with one or more networks such as a local area network (LAN), a general wide area network (WAN), and/or a public network (e.g., the Internet) via network adapter (720). As depicted, network adapter (720) communicates with the other components of host (702) via bus (708). In one embodiment, a plurality of nodes of a distributed file system (not shown) is in communication with the host (702) via the I/O interface (722) or via the network adapter (720). It should be understood that although not shown, other hardware and/or software components could be used in conjunction with host (702). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (706), including RAM (730), cache (732), and storage system (734), such as a removable storage drive and a hard disk installed in a hard disk drive.

Computer programs (also called computer control logic) are stored in memory (706). Computer programs may also be received via a communication interface, such as network adapter (720). Such computer programs, when run, enable the computer system to perform the features of the present embodiments as discussed herein. In particular, the computer programs, when run, enable the processing unit (704) to perform the features of the computer system. Accordingly, such computer programs represent controllers of the computer system.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments.

In an embodiment, the host (702) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Examples of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

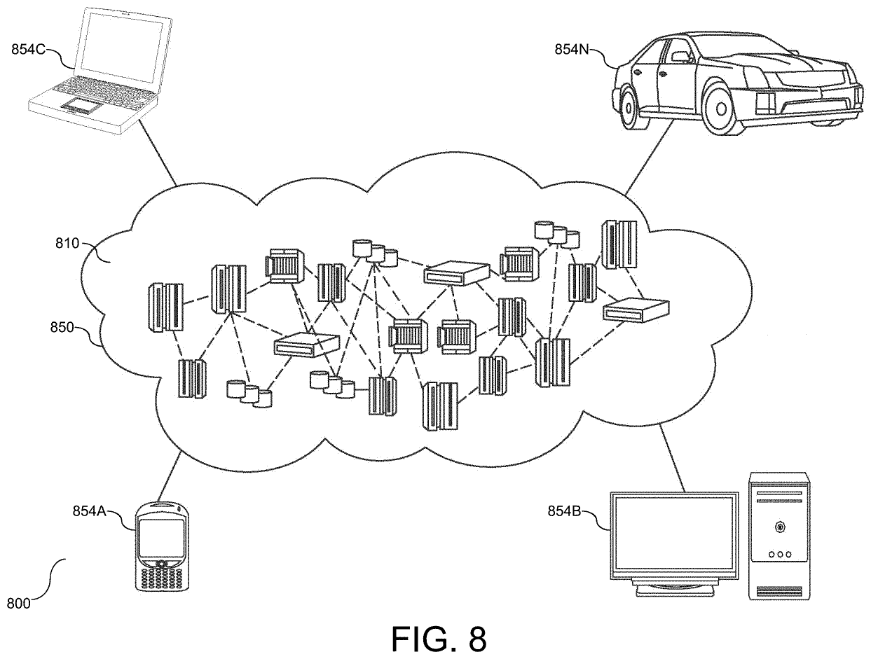

Referring now to FIG. 8, an illustrative cloud computing network (800). As shown, cloud computing network (800) includes a cloud computing environment (850) having one or more cloud computing nodes (810) with which local computing devices used by cloud consumers may communicate. Examples of these local computing devices include, but are not limited to, personal digital assistant (PDA) or cellular telephone (854A), desktop computer (854B), laptop computer (854C), and/or automobile computer system (854N). Individual nodes within nodes (810) may further communicate with one another. They may be grouped (not shown) physically or virtually, in one or more networks, such as Private, Community, Public, or Hybrid clouds as described hereinabove, or a combination thereof. This allows cloud computing environment (800) to offer infrastructure, platforms and/or software as services for which a cloud consumer does not need to maintain resources on a local computing device. It is understood that the types of computing devices (854A), (854B), (854C), and (854N) shown in FIG. 8 are intended to be illustrative only and that the cloud computing environment (850) can communicate with any type of computerized device over any type of network and/or network addressable connection (e.g., using a web browser).

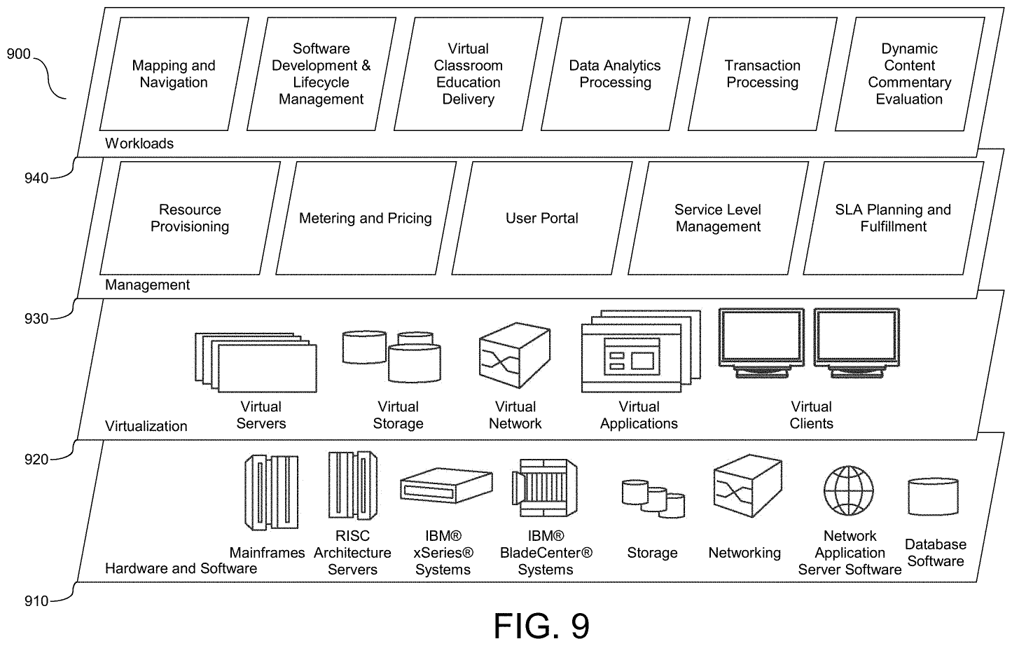

Referring now to FIG. 9, a set of functional abstraction layers (900) provided by the cloud computing network of FIG. 8 is shown. It should be understood in advance that the components, layers, and functions shown in FIG. 9 are intended to be illustrative only, and the embodiments are not limited thereto. As depicted, the following layers and corresponding functions are provided: hardware and software layer (910), virtualization layer (920), management layer (930), and workload layer (940).

The hardware and software layer (910) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (920) provides an abstraction layer from which the following examples of virtual entities may be provided: virtual servers; virtual storage; virtual networks, including virtual private networks; virtual applications and operating systems; and virtual clients.

In an example, the management layer (930) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In an example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

The workload layer (940) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and dynamic content commentary evaluation.

It will be appreciated that there is disclosed herein a system, method, apparatus, and computer program product for dynamically providing a rating from content commentary of a review, preferably a plurality of reviews, associated with a topic, such as a venue.

While particular embodiments of the present embodiments have been shown and described, it will be obvious to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “one or more” or “at least one” and indefinite articles such as “a” or “an”; the same holds true for the use in the claims of definite articles.

The present embodiments may be a system, a method, and/or a computer program product. In addition, selected aspects of the present embodiments may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiments may take the form of computer program product embodied in a computer readable storage medium (or media) having computer readable program instructions thereon for causing a processor to carry out aspects of the present embodiments. Thus embodied, the disclosed system, method, and/or a computer program product are operative to improve the functionality and operation of an artificial intelligence platform to support and enable dynamic content commentary evaluation.

Aspects of the present embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiments. Accordingly, the scope of protection of the embodiments is limited only by the following claims and their equivalents.

What is claimed is:

1. A computer system comprising:
a processing unit operatively coupled to memory;
an artificial intelligence (AI) platform in communication with the processing unit, the AI platform including one or more tools to dynamically provide a rating from content commentary of a review of a topic, comprising:
a natural language (NL) manager to access the review comprising the content commentary associated with the topic and apply natural language processing (NLP) to the content commentary of the accessed review to generate machine-readable sub-topic data and machine-readable sentiment data, the sub-topic data and the sentiment data being derived by the NLP from the content commentary of the accessed review;
an AI manager to apply AI to the sentiment data and the sub-topic data, the AI manager applying AI to:
dynamically identify at least one sub-topic category associated with the sub-topic data;
dynamically identify a sentiment associated with the sentiment data;
dynamically assess a dynamic value to the dynamically identified sentiment; and
dynamically assess a dynamic rating for the accessed review based on the dynamic value; and
a director, operatively coupled to the AI manager, the director to generate output data, the generated output data being based on the dynamic rating.

2. The computer system of claim 1, wherein:
the AI manager is configured to apply AI to:
identify a static value for the accessed review; and
assess a static rating based on the static value; and
the generated output data is based on the dynamic rating and the static rating.

3. The computer system of claim 1, wherein:
the AI platform is configured to access a plurality of reviews comprising content commentary associated with the topic category and, for each of the accessed reviews, apply NLP to the content commentary of the accessed review to generate machine-readable respective sub-topic data and machine-readable respective sentiment data associated with the accessed review, the respective sub-topic data and the respective sentiment data of the accessed review being derived from the content commentary of the accessed review;
the AI manager applying AI to dynamically identify at least one sub-topic category associated with the sub-topic data comprises, for each of the accessed reviews, the AI manager applying AI to dynamically identify at least one respective sub-topic category associated with the respective sub-topic data of the accessed review;
the AI manager applying AI to dynamically identify a sentiment associated with the sentiment data comprises, for each of the accessed reviews, the A manager applying AI to dynamically identify a respective sentiment associated with the respective sentiment data of the accessed review;
the AI manager applying AI to dynamically assess a dynamic value to the dynamically identified sentiment comprises, for each of the accessed reviews, the AI manager applying AI to dynamically assess a respective dynamic value to the dynamically identified sentiment of the accessed review;
the AI manager applying AI to dynamically assess a dynamic rating for the accessed review based on the dynamic value comprises the AI manager applying AI either to (a) dynamically assess respective dynamic ratings for the accessed reviews based on the respective dynamic values and determine the dynamic rating based on the respective dynamic ratings, or (b) dynamically assess the dynamic rating based on the respective dynamic values of the accessed reviews; and
the generated output data is based on the dynamic rating of the accessed reviews.

4. The computer system of claim 3, wherein:
the AI platform is configured to
access personal characteristic data of an entity; and
identify at least one area of interest from the accessed personal characteristic data; and
the AI manager is configured to, for each of the accessed reviews, dynamically determine whether or not the at least one respective sub-topic category shares commonality with the identified at least one area of interest; and
the generated output data is based on the dynamic rating of the accessed reviews for which the respective at least one sub-topic category shares commonality with the identified at least one area of interest, and wherein the generated output data is not based on the dynamic rating of the accessed reviews for which the respective at least one sub-topic category does not share commonality with the identified at least one area of interest.

5. The computer system of claim 3, wherein:
the AI platform is configured to:
access personal characteristic data of an entity;
identify at least one area of interest from the accessed personal characteristic data; and
the AI manager is configure to, for each of the accessed reviews:
dynamically determine whether or not the at least one respective sub-topic category shares commonality with the identified at least one area of interest,
identify a respective static value for the accessed review; and
assess a respective static rating based on the respective static value for the accessed review,
wherein the generated output data is based on the dynamic rating and the respective static ratings of the accessed reviews for which the respective at least one sub-topic category shares commonality with the identified at least one area of interest, and wherein the generated output data is not based on the dynamic rating and the respective static ratings of the accessed reviews for which the respective at least one sub-topic category does not share commonality with the identified at least one area of interest.

6. The computer system of claim 5, wherein the A manager is configured to dynamically derive the personal characteristic data from one or more hypertext transfer protocol (HTTP) cookies of the computer device, a social media profile, a social media site, or a combination thereof.

7. A computer program product to dynamically provide a rating from content commentary of a review associated with a topic, the computer program product comprising a computer readable storage medium having program code embodied therewith, the program code executable by a processor to:
access the review comprising the content commentary associated with the topic and apply natural language processing (NLP) to the content commentary of the accessed review to generate machine-readable sub-topic data and machine-readable sentiment data, the sub-topic data and the sentiment data being derived by the NLP from the content commentary of the accessed review;
apply artificial intelligence (A) to the sub-topic data and the sentiment data, the AI comprising program code to:
dynamically identify at least one sub-topic category associated with the sub-topic data;
dynamically identify a sentiment associated with the sentiment data;
dynamically assess a dynamic value to the dynamically identified sentiment; and
dynamically assess a dynamic rating for the accessed review based on the dynamic value; and
generate output data, the generated output data being based on the dynamic rating.

8. The computer program product of claim 7, wherein:
the program code is executable by the processor to:
identify a static value for the accessed review; and
assess a static rating based on the static value,
the generated output data is based on the dynamic rating and the static rating.

9. The computer program of claim 7, wherein:
the program code executable by the processor comprises program code executable by the processor to access a plurality of reviews comprising content commentary associated with the topic category and, for each of the accessed reviews, apply NLP to the content commentary of the accessed review to generate machine-readable respective sub-topic data and machine-readable respective sentiment data associated with the accessed review, the respective sub-topic data and the respective sentiment data of the accessed review being derived from the content commentary of the accessed review;
the AI comprising program code to dynamically identify at least one sub-topic category associated with the sub-topic data comprises, for each of the accessed reviews, program code to dynamically identify at least one respective sub-topic category associated with the respective sub-topic data of the accessed review;
the AI comprising program code to dynamically identify a sentiment associated with the sentiment data comprises, for each of the accessed reviews, program code to dynamically identify a respective sentiment associated with the respective sentiment data of the accessed review;
the AI comprising program code to dynamically assess a dynamic value to the dynamically identified sentiment comprises, for each of the accessed reviews, program code to dynamically assess a respective dynamic value to the dynamically identified sentiment of the accessed review;
the AI comprising program code to dynamically assess a dynamic rating for the accessed review based on the dynamic value comprises program code either to (a) dynamically assess respective dynamic ratings for the accessed reviews based on the respective dynamic values and determine the dynamic rating based on the respective dynamic ratings, or (b) dynamically assess the dynamic rating based on the respective dynamic values of the accessed reviews; and
the generated output data is based on the dynamic rating of the accessed reviews.

10. The computer program product of claim 9, wherein:
the program code is executable by the processor to:
access personal characteristic data of an entity;
identify at least one area of interest from the accessed personal characteristic data; and
for each of the accessed reviews, dynamically determine whether or not the at least one respective sub-topic category shares commonality with the identified at least one area of interest,
the generated output data is based on the dynamic rating of the accessed reviews for which the respective at least one sub-topic category shares commonality with the identified at least one area of interest, and wherein the generated output data is not based on the dynamic rating of the accessed reviews for which the respective at least one sub-topic category does not share commonality with the identified at least one area of interest.

11. The computer program product of claim 9, wherein:
the program code is executable by the processor to:
access personal characteristic data of an entity;
identify at least one area of interest from the accessed personal characteristic data; and
for each of the accessed reviews:
dynamically determine whether or not the at least one respective sub-topic category shares commonality with the identified at least one area of interest,
identify a respective static value for the accessed review; and
assess a respective static rating based on the respective static value for the accessed review; and
the generated output data is based on the dynamic rating and the respective static ratings of the accessed reviews for which the respective at least one sub-topic category shares commonality with the identified at least one area of interest, and wherein the generated output data is not based on the dynamic rating and the respective static ratings of the accessed reviews for which the respective at least one sub-topic category does not share commonality with the identified at least one area of interest.

12. The computer program product of claim 11, wherein the computer code executable by the processor to access personal characteristic data of an entity comprises computer code executable by the processor to dynamically derive the personal characteristic data from one or more hypertext transfer protocol (HTTP) cookies of the computer device, a social media profile, a social media site, or a combination thereof.

13. The computer program product of claim 11, wherein the personal characteristic data comprises demographic characteristic data, the demographic characteristic data comprising physical impairment, age, religious affiliation, ethnicity, geographical location, or a combination thereof.

14. A method comprising:
accessing a review comprising content commentary associated with a topic category and applying natural language processing (NLP) to the content commentary of the accessed review to generate machine-readable sub-topic data and machine-readable sentiment data, the sub-topic data and the sentiment data being derived by the NLP from the content commentary of the accessed review;
applying artificial intelligence (A) to the sub-topic data and the sentiment data, the AI:
dynamically identifying at least one sub-topic category associated with the sub-topic data;
dynamically identifying a sentiment associated with the sentiment data;
dynamically assessing a dynamic value to the dynamically identified sentiment; and
dynamically assessing a dynamic rating for the accessed review based on the dynamic value; and
generating output data, the generated output data being based on the dynamic rating.

15. The method of claim 14, further comprising:
identifying a static value for the accessed review; and
assessing a static rating based on the static value,
wherein the generated output data is based on the dynamic rating and the static rating.

16. The method of claim 14, wherein:
said accessing a review comprises accessing a plurality of reviews comprising content commentary associated with the topic category and, for each of the accessed reviews, applying NLP to the content commentary of the accessed review to generate machine-readable respective sub-topic data and machine-readable respective sentiment data associated with the accessed review, the respective sub-topic data and the respective sentiment data of the accessed review being derived from the content commentary of the accessed review;
said dynamically identifying at least one sub-topic category associated with the sub-topic data comprises, for each of the accessed reviews, dynamically identifying at least one respective sub-topic category associated with the respective sub-topic data of the accessed review;
said dynamically identifying a sentiment associated with the sentiment data comprises, for each of the accessed reviews, dynamically identifying a respective sentiment associated with the respective sentiment data of the accessed review;
said dynamically assessing a dynamic value to the dynamically identified sentiment comprises, for each of the accessed reviews, dynamically assessing a respective dynamic value to the dynamically identified sentiment of the accessed review;
said dynamically assessing a dynamic rating for the accessed review based on the dynamic value comprises either (a) dynamically assessing respective dynamic ratings for the accessed reviews based on the respective dynamic values and determining the dynamic rating based on the respective dynamic ratings, or (b) dynamically assessing the dynamic rating based on the respective dynamic values of the accessed reviews; and
the generated output data is based on the dynamic rating of the accessed reviews.

17. The method of claim 16, further comprising:
accessing personal characteristic data of an entity;
identifying at least one area of interest from the accessed personal characteristic data; and
for each of the accessed reviews, dynamically determining whether or not the at least one respective sub-topic category shares commonality with the identified at least one area of interest,
wherein the generated output data is based on the dynamic rating of the accessed reviews for which the respective at least one sub-topic category shares commonality with the identified at least one area of interest, and wherein the generated output data is not based on the dynamic rating of the accessed reviews for which the respective at least one sub-topic category does not share commonality with the identified at least one area of interest.

18. The method of claim 16, further comprising:
accessing personal characteristic data of an entity;
identifying at least one area of interest from the accessed personal characteristic data; and
for each of the accessed reviews:
dynamically determining whether or not the at least one respective sub-topic category shares commonality with the identified at least one area of interest,
identifying a respective static value for the accessed review; and
assessing a respective static rating based on the respective static value for the accessed review,
wherein the generated output data is based on the dynamic rating and the respective static ratings of the accessed reviews for which the respective at least one sub-topic category shares commonality with the identified at least one area of interest, and wherein the generated output data is not based on the dynamic rating and the respective static ratings of the accessed reviews for which the respective at least one sub-topic category does not share commonality with the identified at least one area of interest.

19. The method of claim 18, wherein said accessing of personal characteristic data comprises dynamically deriving the personal characteristic data from one or more hypertext transfer protocol (HTTP) cookies of the computer device, a social media profile, a social media site, or a combination thereof.

20. The method of claim 18, wherein the personal characteristic data comprises demographic characteristic data, the demographic characteristic data comprising physical impairment, age, religious affiliation, ethnicity, geographical location, or a combination thereof.
